(19) United States
(12) Patent Application Publication
(10) Pub. No.: US 2016/0336007 A1
(43) Pub. Date: Nov. 17, 2016

(54) SPEECH SEARCH DEVICE AND SPEECH SEARCH METHOD

(71) Applicant: MITSUBISHI ELECTRIC CORPORATION, Tokyo (JP)

(72) Inventor: Toshiyuki HANAZAWA, Tokyo (JP)

(73) Assignee: MITSUBISHI ELECTRIC CORPORATION, Tokyo (JP)

(21) Appl. No.: 15/111,860

(22) PCT Filed: Feb. 6, 2014
(86) PCT No.: PCT/JP2014/052775

§ 371 Date: Jul. 15, 2016

(51) Int. Cl. G10L 15/10; G06F 17/22; G10L 15/183; G06F 17/30

(52) U.S. Cl. CPC G10L 15/10; G06F 17/30684; G06F 17/2211; G10L 15/183

(57) ABSTRACT

Disclosed is a speech search device including a recognizer 2 that refers to an acoustic model and language models having different learning data and performs voice recognition on an input speech, to acquire a recognized character string for each language model, a character string comparator 6 that compares the recognized character string for each language models with the character strings of search target words stored in a character string dictionary, and calculates a character string matching score showing the degree of matching of the recognized character string with respect to each of the character strings of the search target words, to acquire both a character string having the highest character string matching score and this character string matching score for each recognized character strings, and a search result determinator 8 that refers to the acquired score and outputs one or more search target words in descending order of the scores.

### FIELD OF THE INVENTION

The present invention relates to a speech search device for and a speech search method of performing a comparison process on recognition results acquired from a plurality of language models for each of which a language likelihood is provided with respect to the character strings of search target words, to acquire a search result.

### BACKGROUND OF THE INVENTION

Conventionally, in most cases, a statistics language model with which a language likelihood is calculated by using a statistic of learning data, which will be described later, is used as a language model for which a language likelihood is provided. In voice recognition using a statistics language model, when aiming at recognizing an utterance including one of various words or expressions, it is necessary to construct a statistics language model by using various documents as learning data for the language model.

A problem is however that in a case of constructing a single statistics language model by using a wide range of learning data, the statistics language model is not necessarily optimal to recognize an utterance about a certain specific subject, e.g., the weather.

As a method of solving this problem, nonpatent reference 1 discloses a technique of classifying learning data about a language model according to some subjects and learning statistics language models by using the learning data which are classified according to the subjects, and further performing a recognition comparison by using each of the statistics language models at the time of recognition, to provide a candidate having the highest recognition score as a recognition result. It is reported by this technique that when recognizing an utterance about a specific subject, the recognition score of a recognition candidate provided by a language model corresponding to the subject becomes high, and the recognition accuracy is improved as compared with the case of using a single statistics language model.

### RELATED ART DOCUMENT

### Nonpatent Reference

Nonpatent reference 1: Nakajima et al., “Simultaneous Word Sequence Search for Parallel Language Models in Large Vocabulary Continuous Speech Recognition”, Information Processing Society of Japan Journal, 2004, Vol. 45, No. 12

### SUMMARY OF THE INVENTION

### Problems to be Solved by the Invention

A problem with the technique disclosed by above-mentioned nonpatent reference 1 is however that because a recognition process is performed by using a plurality of statistics language models having different learning data, a comparison on the language likelihood which is used for the calculation of the recognition score cannot be strictly performed between the statistics language models having different learning data. This is because while the language likelihood is calculated on the basis of the trigram probability for the word string of each recognition candidate in the case in which, for example, the statistics language models are trigram models of words, the trigram probability has a different value also for the same word string in the case in which the language models have different learning data.

The present invention is made in order to solve the above-mentioned problem, and it is therefore an object of the present invention to provide a technique of acquiring comparable recognition scores also when performing a recognition process by using a plurality of statistics language models having different learning data, thereby improving the search accuracy.

### Means for Solving the Problem

According to the present invention, there is provided a speech search device including: a recognizer to refer to an acoustic model and a plurality of language models having different learning data and perform voice recognition on an input speech, to acquire a recognized character string for each of the plurality of language models; a character string dictionary storage to store a character string dictionary in which pieces of information showing character strings of search target words each serving as a target for speech search are stored; a character string comparator to compare the recognized character string for each of the plurality of language models, the recognized character string being acquired by the recognizer, with the character strings of the search target words which are stored in the character string dictionary and calculate a character string matching score showing a degree of matching of the recognized character string with respect to each of the character strings of the search target words, to acquire both the character string of a search target word having the highest character string matching score and this character string matching score for each of the recognized character strings; and a search result determinator to refer to the character string matching score acquired by the character string comparator and output, as a search result, one or more search target words in descending order of the character string matching scores.

### Advantages of the Invention

According to the present invention, also when a recognition process on the input speech is performed by using the plurality of language models having different learning data, recognition scores which can be compared between the language models can be acquired and the search accuracy of the speech search can be improved.

### BRIEF DESCRIPTION OF THE FIGURES

FIG. 1 is a block diagram showing the configuration of a speech search device according to Embodiment 1;

FIG. 2 is a diagram showing a method of generating a character string dictionary of the speech search device according to Embodiment 1;

FIG. 3 is a flow chart showing the operation of the speech search device according to Embodiment 1;

FIG. 4 is a block diagram showing the configuration of a speech search device according to Embodiment 2;

FIG. 5 is a flow chart showing the operation of the speech search device according to Embodiment 2;

FIG. 6 is a block diagram showing the configuration of a speech search device according to Embodiment 3;

FIG. 7 is a flow chart showing the operation of the speech search device according to Embodiment 3;

FIG. 8 is a block diagram showing the configuration of a speech search device according to Embodiment 4; and

FIG. 9 is a flow chart showing the operation of the speech search device according to Embodiment 4.

### EMBODIMENTS OF THE INVENTION

Hereafter, in order to explain this invention in greater detail, the preferred embodiments of the present invention will be described with reference to the accompanying drawings.

### Embodiment 1

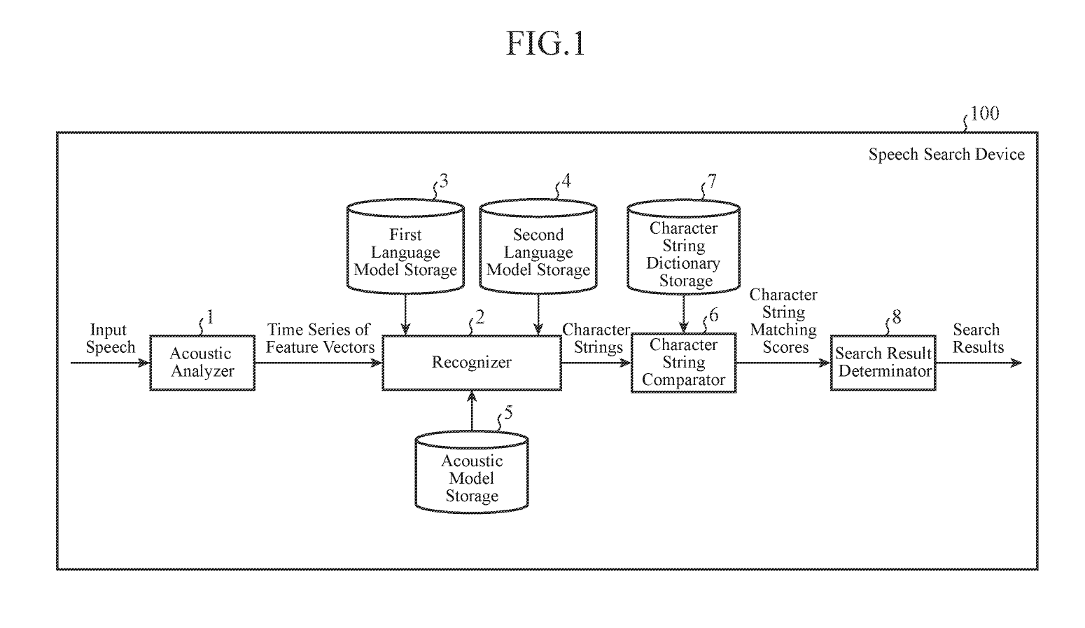

FIG. 1 is a block diagram showing the configuration of a speech search device according to Embodiment 1 of the present invention.

The speech search device 100 is comprised of an acoustic analyzer 1, a recognizer 2, a first language model storage 3, a second language model storage 4, an acoustic model storage 5, a character string comparator 6, a character string dictionary storage 7 and a search result determinator 8.

The acoustic analyzer 1 performs an acoustic analysis on an input speech, and converts this input speech into a time series of feature vectors. A feature vector is, for example, one to N dimensional data about MFCC (Mel Frequency Cepstral Coefficient). N is, for example, 16.

The recognizer 2 acquires character strings each of which is the closest to the input speech by performing a recognition comparison by using a first language model stored in the first language model storage 3 and a second language model stored in the second language model storage 4, and an acoustic model stored in the acoustic model storage 5. In further detail, the recognizer 2 performs a recognition comparison on the time series of feature vectors after being converted by the acoustic analyzer 1 by using, for example, a Viterbi algorithm, to acquire a recognition result having the highest recognition score with respect to each of the language models, and outputs character strings which are recognition results.

In this Embodiment 1, a case in which each of the character strings is a syllable train representing the pronunciation of a recognition result will be explained as an example. Further, it is assumed that a recognition score is calculated from a weighted sum of an acoustic likelihood which is calculated using the acoustic model according to the Viterbi algorithm and a language likelihood which is calculated using a language model.

Although the recognizer 2 also calculates, for each character string, the recognition score which is the weighted sum of the acoustic likelihood calculated using the acoustic model and the language likelihood calculated using a language model, as mentioned above, the recognition score has a different value even if the character string of the recognition result based on each language model is the same. This is because when the character strings of the recognition results are the same, the acoustic likelihood is the same for both the language models, but the language likelihood differs between the language models. Therefore, strictly speaking, the recognition score of the recognition result based on each language model is not a comparable value. Therefore, this Embodiment 1 is characterized that the character string comparator 6, which will be described later, calculates a score which can be compared between both the language models, and the search result determinator 8 determines final search results.

Each of the first and second language model storages 3 and 4 stores a language model in which each of names serving as a search target is subjected to a morphological analysis so as to be decomposed into a sequence of words, and which is thus generated as a statistics language model of the word sequence. The first language model and the second language model are generated before a speech search is performed.

An explanation will be made by using a concrete example. When a search target is, for example, a facility name “ [symbol] [symbol] (nacinotaki)”, this facility name is decomposed into a sequence of three words of “ [symbol] (naci)”, “ [symbol] (no)” and “ [symbol] (taki)”, and a statistics language model is generated. Although it is assumed in this Embodiment 1 that each statistics language model is a trigram model of words, each statistics language model can be constructed by using an arbitrary language model, such as a bigram or unigram model. By decomposing each facility name into a sequence of words, speech recognition can be performed also when an utterance is not given using a correct facility name, such as when an utterance “ [symbol] (nacitaki)” is given.

The acoustic model storage 5 stores the acoustic model in which feature vectors of speeches are modeled. As the acoustic model, an HMM (Hidden Markov Model) is provided, for example. The character string comparator 6 refers to a character string dictionary stored in the character string dictionary storage 7, and performs a comparison process on the character strings of the recognition results outputted from the recognizer 2. The character string comparator performs the comparison process by sequentially referring to the inverted file of the character string dictionary, starting with the syllable at the head of the character string of each of the recognition results, and adds “1” to the character string matching score of a facility name including that sound. The character string comparator performs the process on up to the final syllable of the character string of each of the recognition results. The character string comparator then outputs the name having the highest character string matching score together with the character string matching score for each of the character strings of the recognition results.

The character string dictionary storage 7 stores the character string dictionary which consists of the inverted file in which syllables are defined as search words. The inverted file is generated from, for example, the syllable trains of facility names for each of which an ID number is provided. The character string dictionary is generated before a speech search is performed.

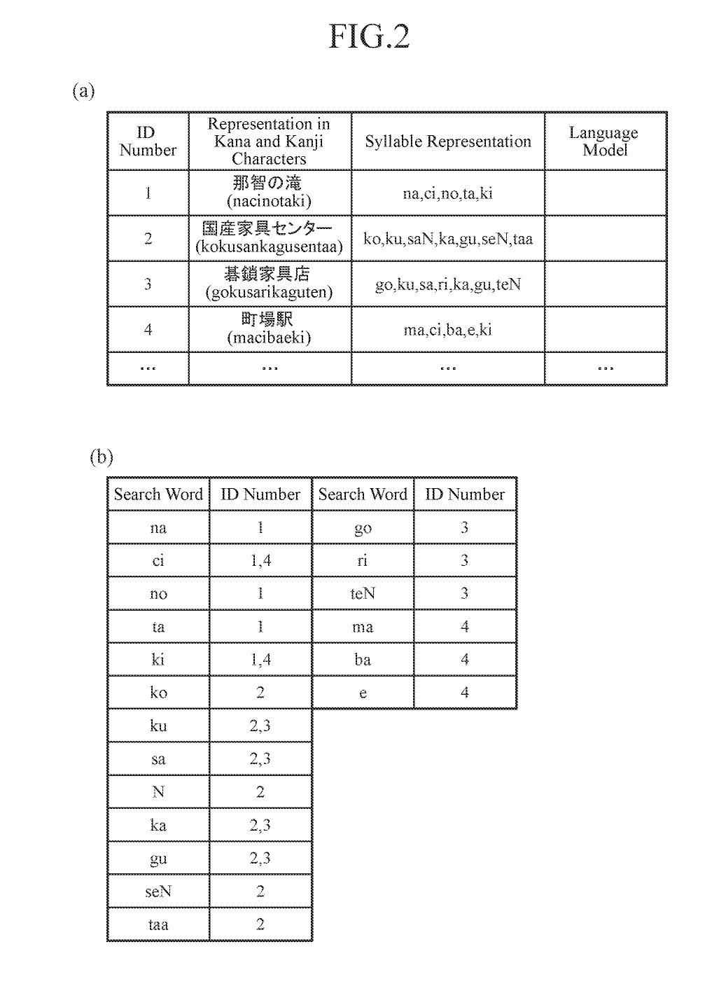

Hereafter, a method of generating the inverted file will be explained concretely while referring to FIG. 2.

FIG. 2(a) shows an example in which each facility name is expressed by an “ID number”, a “representation in kana and kanji characters”, a “syllable representation”, and a “language model.” FIG. 2(b) shows an example of the character string dictionary generated on the basis of the information about facility names shown in FIG. 2(a). With each syllable which is a “search word” in FIG. 2(b), the ID number of each name including that syllable is associated. In the example shown in FIG. 2, the inverted file is generated using the search targets and all the facility names.

The search result determinator 8 refers to the character string matching scores outputted from the character string comparator 6, sorts the character strings of the recognition results in descending order of their character string matching scores, and sequentially outputs one or more character strings, as search results, in descending order of their character string matching scores.

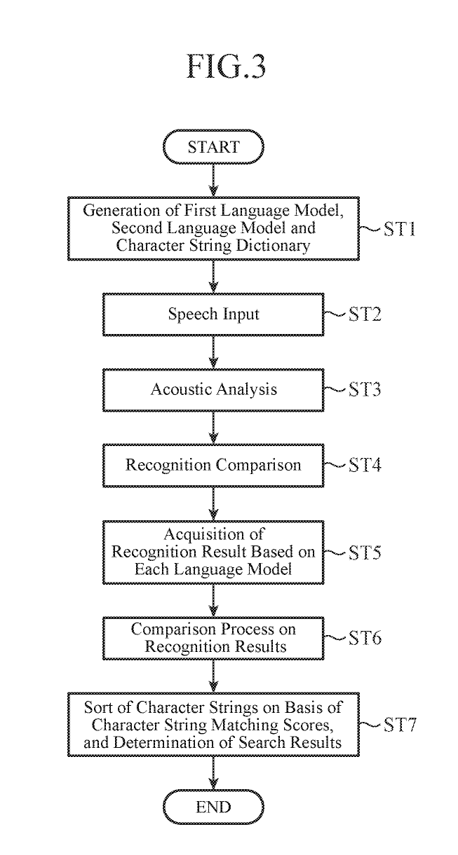

Next, the operation of the speech search device 100 will be explained while referring to FIG. 3.

FIG. 3 is a flowchart showing the operation of the speech search device according to Embodiment 1 of the present invention. The speech search device generates a first language model, a second language model and a character string dictionary, and stores them in the first language model storage 3, the second language model storage 4 and the character string dictionary storage 7, respectively (step ST1). Next, when speech input is performed (step ST2), the acoustic analyzer 1 performs an acoustic analysis on the input speech and converts this input speech into a time series of feature vectors (step ST3).

The recognizer 2 performs a recognition comparison on the time series of feature vectors after being converted in step ST3 by using the first language model, the second language model and the acoustic model, and calculates recognition scores (step ST4). The recognizer 2 further refers to the recognition scores calculated in step ST4, and acquires a recognition result having the highest recognition score with respect to the first language model and a recognition result having the highest recognition score with respect to the second language model (step ST5). It is assumed that each recognition result acquired in step ST5 is a character string.

The character string comparator 6 refers to the character string dictionary stored in the character string dictionary storage 7 and performs a comparison process on the character string of each recognition result acquired in step ST5, and outputs a character string having the highest character string matching score together with this character string matching score (step ST6). Next, by using the character strings and the character string matching scores which are outputted in step ST6, the search result determinator 8 sorts the character strings in descending order of their character string matching scores and determines and outputs search results (step ST7), and then ends the processing.

Next, the flow chart shown in FIG. 3 will be explained in greater detail by providing a concrete example. Hereafter, the explanation will be made by providing, as an example, a case in which the names of facilities and tourist attractions (referred to as facilities from here on) in the whole country of Japan are assumed to be text documents each of which consists of some words, and the facility names are set as search targets. By performing a facility name search, instead of by simply performing typical word speech recognition, by using the scheme of a text search, also when the user does not memorize the facility name of a search target correctly, the facility name can be searched for according to a partial match of the text.

First, the speech search device, as step ST1, generates a language model which serves as the first language model and in which the facility names in the whole country are set as learning data, and also generates a language model which serves as the second language model and in which the facility names in Kanagawa Prefecture are set as learning data. The above-mentioned language models are generated on the assumption that the user of the speech search device 100 exists in Kanagawa Prefecture and searches for a facility in Kanagawa Prefecture in many cases, but may also search for a facility in another area in some cases. It is further assumed that the speech search device generates a dictionary as shown in FIG. 2(b) as the character string dictionary, and the character string dictionary storage 7 stores this dictionary.

Hereafter, a case in which the utterance content of the input speech is “ [symbol] (gokusarikagu)”, and this facility is the only single one in Kanagawa Prefecture and its name is an unusual name will be explained in this example. When the utterance content of the speech input in step ST2 is “ [symbol] [symbol] (gokusarikagu)”, for example, an acoustic analysis is performed on “ [symbol] (gokusarikagu)” as step ST3, and a recognition comparison is performed as step ST4. Further, the following recognition results are acquired as step ST5.

It is assumed that the recognition result based on the first language model is a character string “ko, ku, sa, i, ka, gu.” “,” in the character string is a symbol showing a separator between syllables. This is because the first language model is a statistics language model which is generated by setting the facility names in the whole country as the learning data, as mentioned above, and hence there is a tendency that a word having a relatively-low frequency of appearance in the learning data is hard to be recognized because its language likelihood calculated on the basis of trigram probabilities becomes low. It is assumed that, as a result, the recognition result acquired using the first language model is “ [symbol] (kokusaikagu)” which is a misrecognized one.

On the other hand, it is assumed that the recognition result based on the second language model is a character string “go, ku, sa, ri, ka, gu.” This is because the second language model is a statistics language model which is generated by setting the facility names in Kanagawa Prefecture as the learning data, as mentioned above, and hence the total number of learning data in the second language model is greatly smaller than that of learning data in the first language model, the relative frequency of appearance of “ [symbol] (gokusarikagu)” in the entire learning data in the second language model is higher than that in the first language model, and its language likelihood becomes high.

As mentioned above, as step ST5, the recognizer 2 acquires Txt(1)=“ko, ku, sa, i, ka, gu” which is the character string of the recognition result based on the first language model and Txt(2)=“go, ku, sa, ri, ka, gu” which is the character string of the recognition result based on the second language model.

Next, as step ST6, the character string comparator 6 performs the comparison process on both “ko, ku, sa, i, ka, gu” which is the character string of the recognition result using the first language model, and “go, ku, sa, ri, ka, gu” which is the character string of the recognition result using the second language model, by using the character string dictionary, and outputs character strings each having the highest character string matching score together with their character string matching scores.

Concretely explaining the comparison process on the above-mentioned character strings, because the following four syllables: ko, ku, ka and gu, among the six syllables which construct “ko, ku, sa, i, ka, gu” which is the character string of the recognition result using the first language model, are included in the syllable train “ko, ku, saN, ka, gu, seN, taa” of “ [symbol] (kokusankagusentaa)”, the character string matching score is “4” and is the highest. On the other hand, because the six syllables which construct “go, ku, sa, ri, ka, gu” which is the character string of the recognition result using the second language model are all included in the syllable train “go, ku, sa, ri, ka, gu, teN” of “ [symbol] (gokusarikaguten)”, the character string matching score is “6”, and is the highest.

On the basis of those results, the character string comparator 6 outputs the character string “ [symbol] (kokusankagusentaa)” and the character string matching score S(1)=4 as comparison results corresponding to the first language model, and the character string “ [symbol] (gokusarikaguten)” and the character string matching score S(2)=6 as comparison results corresponding to the second language model.

In this case, S(1) denotes the character string matching score for the character string Txt(1) according to the first language model, and S(2) denotes the character string matching score for the character string Txt(2) according to the second language model. Because the character string comparator 6 calculates the character string matching scores for both the character string Txt(1) and the character string Txt(2), which are inputted thereto, according to the same criterion, the character string comparator can compare the likelihoods of the search results by using the character string matching scores calculated thereby.

Next, as step ST7, by using the inputted character string “ [symbol] (kokusankagusentaa)” and the character string matching score S(1)=4, and the character string “ [symbol] (gokusarikaguten)” and the character string matching score S(2)=6, the search result determinator 8 sorts the character strings in descending order of their character string matching scores and outputs search results in which the first place is “ [symbol] (gokusarikaguten)” and the second place is “ [symbol] [symbol] (kokusankagusentaa).” In this way, the speech search device becomes able to search for even a facility name having a low frequency of appearance.

Next, a case in which the utterance content of the input speech is about a facility placed outside Kanagawa Prefecture will be explained as an example.

When the utterance content of the speech input in step ST2 is, for example, “ [symbol] (nacinotaki)”, an acoustic analysis is performed on “ [symbol] (nacinotaki)” as step ST3, and a recognition comparison is performed as step ST4. Further, as step ST5, the recognizer 2 acquires a character string Txt(1) and a character string Txt(2) which are recognition results. Each character string is a syllable train representing the utterance of a recognition result, like above-mentioned character strings.

The recognition results acquired in step ST5 will be explained concretely. The recognition result based on the first language model is a character string “na, ci, no, ta, ki.” “,” in the character string is a symbol showing a separator between syllables. This is because the first language model is a statistics language model which is generated by setting the facility names in the whole country as the learning data, as mentioned above, and hence “ [symbol] (naci)” and “ [symbol] (taki)” exist with a relatively high frequency in the learning data and the utterance content in step ST2 is recognized correctly. It is then assumed that, as a result, the recognition result is “ [symbol] (nacinotaki).”

On the other hand, the recognition result based on the second language model is a character string “ma, ci, no, e, ki.” This is because the second language model is a statistics language model which is generated by setting the facility names in Kanagawa Prefecture as the learning data, as mentioned above, and hence “ [symbol] (naci)” does not exist in the recognized vocabulary. It is then assumed that, as a result, the recognition result is “ [symbol] (macinoeki).” As mentioned above, as step ST5, Txt(1)=“na, ci, no, ta, ki” which is the character string of the recognition result based on the first language model and Txt(2)=“ma, ci, no, e, ki” which is the character string of the recognition result based on the second language model are acquired.

Next, as step ST6, the character string comparator 6 performs the comparison process on both “na, ci, no, ta, ki” which is the character string of the recognition result using the first language model, and “ma, ci, no, e, ki” which is the character string of the recognition result using the second language model, and outputs character strings each having the highest character string matching score together with their character string matching scores.

Concretely explaining the comparison process on the above-mentioned character strings, because the five syllables which construct “na, ci, no, ta, ki” which is the character string of the recognition result using the first language model are all included in the syllable train “na, ci, no, ta, ki” of “ [symbol] (nacinotaki)”, the character string matching score is “5” and is the highest. On the other hand, because the following four syllables: ma, ci, e and ki, among the six syllables which construct “ma, ci, no, e, ki” which is the character string of the recognition result using the second language model, are included in the syllable train “ma, ci, ba, e, ki” of “ [symbol] [symbol] (macibaeki)”, the character string matching score is “4” and is the highest.

On the basis of those results, the character string comparator 6 outputs the character string “ [symbol] (nacinotaki)” and the character string matching score S(1)=5 as comparison results corresponding to the first language model, and the character string “ [symbol] (macibaeki)” and the character string matching score S(2)=4 as comparison results corresponding to the second language model.

Next, as step ST7, by using the inputted character string “ [symbol] (nacinotaki)” and the character string matching score S (1)=5, and the character string “ [symbol] (macibaeki)” and the character string matching score S(2)=4, the search result determinator 8 sorts the character strings in descending order of their character string matching scores and outputs search results in which the first place is “ [symbol] (nacinotaki)” and the second place is “ [symbol] (macibaeki).” In this way, the speech search device can search for even a facility name which does not exist in the second language model with a high degree of accuracy.

As mentioned above, because the speech search device according to this Embodiment 1 is configured in such a way as to include the recognizer 2 that acquires a character string which is a recognition result corresponding to each of the first and second language models, the character string comparator 6 that calculates a character string matching score of each character string which the recognizer 2 acquires by referring to the character string dictionary, and the search result determinator 8 that sorts character strings on the basis of character string matching scores, and determines search results, comparable character string matching scores can be acquired also when the recognition process is performed by using the plurality of language models having different learning data, and the search accuracy can be improved.

In above-mentioned Embodiment 1, although the example using the two language models is shown, three or more language models can be alternatively used. For example, the speech search device can be configured in such a way as to generate and use a third language model in which the names of facilities existing in, for example, Tokyo Prefecture are defined as learning data, in addition to the above-mentioned first and second language models.

Further, although in above-mentioned Embodiment 1 the configuration in which the character string comparator 6 uses the comparing method using an inverted file is shown, the character string comparator can be alternatively configured in such a way as to use an arbitrary method of receiving a character string and calculating a comparison score. For example, the character string comparator can use DP matching of character strings as the comparing method.

Although in above-mentioned Embodiment 1 the configuration of assigning the single recognizer 2 to the first language model storage 3 and the second language model storage 4 is shown, there can be provided a configuration of assigning different recognizers to the language models, respectively.

### Embodiment 2

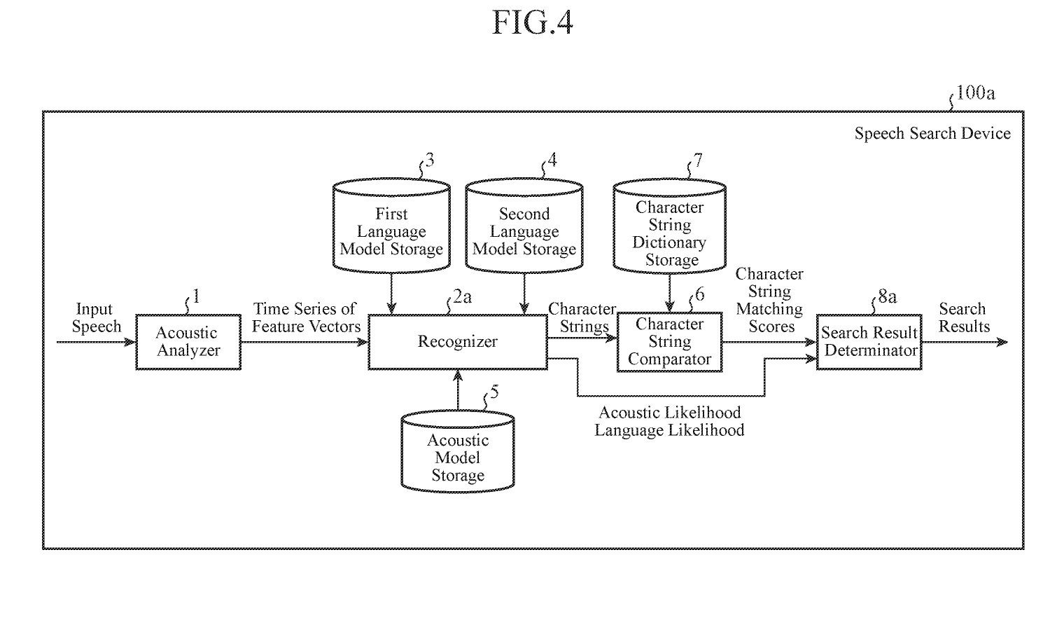

FIG. 4 is a block diagram showing the configuration of a speech search device according to Embodiment 2 of the present invention.

In the speech search device 100a according to Embodiment 2, a recognizer 2a outputs, in addition to character strings which are recognition results, an acoustic likelihood and a language likelihood of each of those character strings to a search result determinator 8a. The search result determinator 8a determines search results by using the acoustic likelihood and the language likelihood in addition to character string matching scores.

Hereafter, the same components as those of the speech search device 100 according to Embodiment 1 or like components are denoted by the same reference numerals as those used in FIG. 1, and the explanation of the components will be omitted or simplified.

The recognizer 2a performs a recognition comparison process to acquire a recognition result having the highest recognition score with respect to each language model, and outputs a character string which is the recognition result to a character string comparator 6, like that according to Embodiment 1. The character string is a syllable train representing the pronunciation of the recognition result, like in the case of Embodiment 1.

The recognizer 2a further outputs the acoustic likelihood and the language likelihood for the character string of the recognition result calculated in the recognition comparison process on the first language model, and the acoustic likelihood and the language likelihood for the character string of the recognition result calculated in the recognition comparison process on the second language model to the search result determinator 8a.

The search result determinator 8a calculates a weighted sum of at least two of the following three values including, in addition to the character string matching score shown in Embodiment 1, the language likelihood and the acoustic likelihood for each of the character strings outputted from the recognizer 2a, to calculate a total score. The search result determinator sorts the character strings of recognition results in descending order of their calculated total scores, and sequentially outputs, as a search result, one or more character strings in descending order of the total scores.

Explaining in greater detail, the search result determinator 8a receives the character string matching score S(1) for the first language model and the character string matching score S(2) for the second language model, which are outputted from the character string comparator 6, the acoustic likelihood Sa(1) and the language likelihood Sg(1) for the recognition result based on the first language model, and the acoustic likelihood Sa(2) and the language likelihood Sg(2) for the recognition result based on the second language model, and calculates a total score ST(i) by using equation (1) shown below.

ST(i)=S(i)+wa*Sa(i)+wg*Sg(i) (1)

In the equation (1), i=1 or 2 in the example of this Embodiment 2, and ST(1) denotes the total score of the search result corresponding to the first language model and ST(2) denotes the total score of the search result corresponding to the second language model. Further, wa and wg are constants each of which is determined in advance and is zero or more. In addition, either wa or wg can be 0, but both wa and wg are set to values other than 0. In the above-mentioned way, the total score ST(i) is calculated on the basis of the equation (1), and the character strings of the recognition results are sorted in descending order of their total scores and one or more character strings are sequentially outputted as search results in descending order of the total scores.

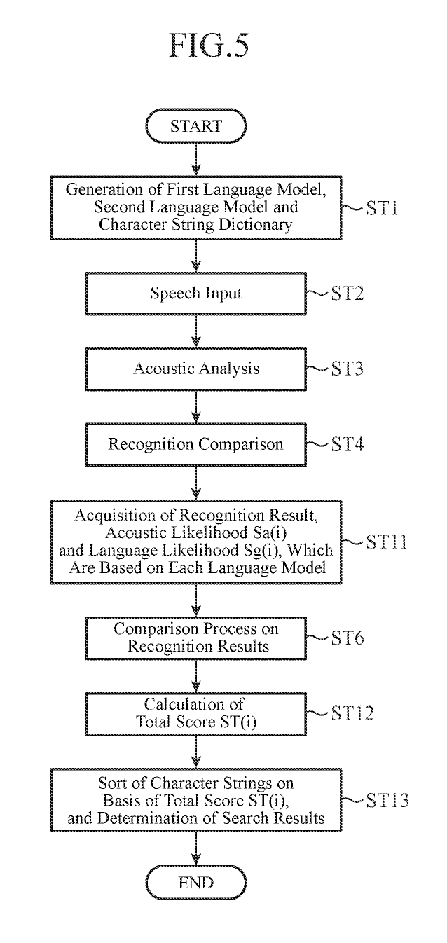

Next, the operation of the speech search device 100a according to Embodiment 2 will be explained while referring to FIG. 5. FIG. 5 is a flow chart showing the operation of the speech search device according to Embodiment 2 of the present invention. Hereafter, the same steps as those of the speech search device according to Embodiment 1 are denoted by the same reference characters as those used in FIG. 3, and the explanation of the steps will be omitted or simplified.

After processes of steps ST1 to ST4 are performed, the recognizer 2a acquires character strings each of which is a recognition result having the highest recognition result, like that according to Embodiment 1, and also acquires the acoustic likelihood Sa(1) and the language likelihood Sg(1) for the character string according to the first language model and the acoustic likelihood Sa(2) and the language likelihood Sg(2) for the character string according to the second language model, which are calculated in the recognition comparison process of step ST4 (step ST11). The character strings acquired in step ST11 are outputted to the character string comparator 6, and the acoustic likelihoods Sa(i) and the language likelihoods Sg(i) are outputted to the search result determinator 8a.

The character string comparator 6 performs a comparison process on each of the character strings of the recognition results acquired in step ST11, and outputs a character string having the highest character string matching score together with this character string matching score (step ST6). Next, the search result determinator 8a calculates total scores ST(i) by using the acoustic likelihood Sa(1) and the language likelihood Sg(1) for the first language model and the acoustic likelihood Sa(2) and the language likelihood Sg(2) for the second language model, which are acquired in step ST11 (step ST12). In addition, by using the character strings outputted in step ST6, and the total scores ST(i) (ST(1) and ST(2)) calculated in step ST12, the search result determinator 8a sorts the character strings in descending order of the total scores ST(i) and determines and outputs search results (step ST13), and ends the processing.

As mentioned above, because the speech search device according to this Embodiment 2 is configured in such a way as to include the recognizer 2a that acquires character strings each of which is a recognition result having the highest recognition result, and also acquires an acoustic likelihood Sa(i) and a language likelihood Sg(i) for the character string according to each language model, and the search result determinator 8a that determines search results by using a total score ST(i) which is calculated by taking into consideration the acoustic likelihood Sa(i) and the language likelihood Sg(i) acquired, the likelihoods of the speech recognition results can be reflected and the search accuracy can be improved.

### Embodiment 3

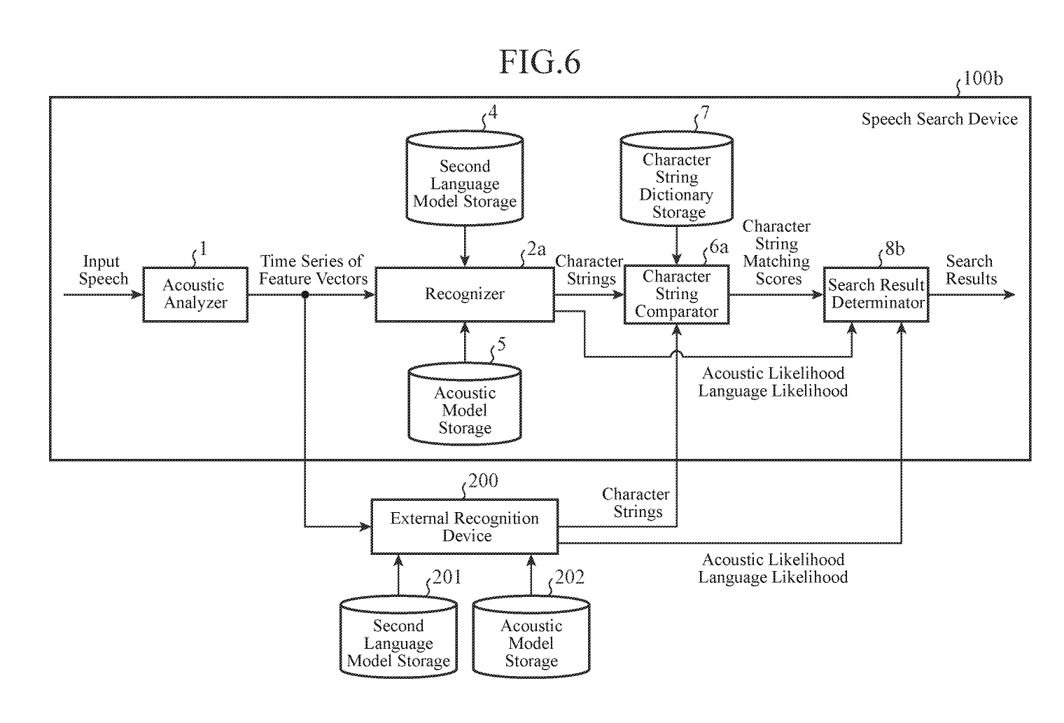

FIG. 6 is a block diagram showing the configuration of a speech search device according to Embodiment 3 of the present invention.

The speech search device 100b according to Embodiment 3 includes a second language model storage 4, but does not include a first language model storage 3, in comparison with the speech search device 100a shown in Embodiment 2. Therefore, a recognition process using a first language model is performed by using an external recognition device 200.

Hereafter, the same components as those of the speech search device 100a according to Embodiment 2 or like components are denoted by the same reference numerals as those used in FIG. 4, and the explanation of the components will be omitted or simplified.

The external recognition device 200 can consist of, for example, a server or the like having high computational capability, and acquires a character string which is the closest to a time series of feature vectors inputted from an acoustic analyzer 1 by performing a recognition comparison by using a first language model stored in a first language model storage 201 and an acoustic model stored in an acoustic model storage 202. The external recognition device outputs the character string which is a recognition result whose acquired recognition score is the highest to a character string comparator 6a of the speech search device 100b, and also outputs an acoustic likelihood and a language likelihood of that character string to a search result determinator 8b of the speech search device 100b.

The first language model storage 201 and the acoustic model storage 202 store the same language model and the same acoustic model as those stored in the first language model storage 3 and the acoustic model storage 5 which are shown in, for example, Embodiment 1 and Embodiment 2.

A recognizer 2a acquires a character string which is the closest to the time series of feature vectors inputted from the acoustic analyzer 1 by performing a recognition comparison by using a second language model stored in the second language model storage 4 and an acoustic model stored in an acoustic model storage 5. The recognizer outputs the character string which is a recognition result whose acquired recognition score is the highest to the character string comparator 6a of the speech search device 100b, and also outputs an acoustic likelihood and a language likelihood to the search result determinator 8b of the speech search device 100b.

The character string comparator 6a refers to a character string dictionary stored in a character string dictionary storage 7, and performs a comparison process on the character string of the recognition result outputted from the recognizer 2a and the character string of the recognition result outputted from the external recognition device 200. The character string comparator outputs a name having the highest character string matching score to the search result determinator 8b together with the character string matching score, for each of the character strings of the recognition results.

The search result determinator 8b calculates a weighted sum of at least two of the following three values including, in addition to the character string matching score outputted from the character string comparator 6a, the acoustic likelihood Sa(i) and the language likelihood Sg(i) for each of the two character strings outputted from the recognizer 2a and the external recognition device 200, to calculate ST(i). The search result determinator sorts the character strings of the recognition results in descending order of the calculated total scores, and sequentially outputs, as a search result, one or more character strings in descending order of the total scores.

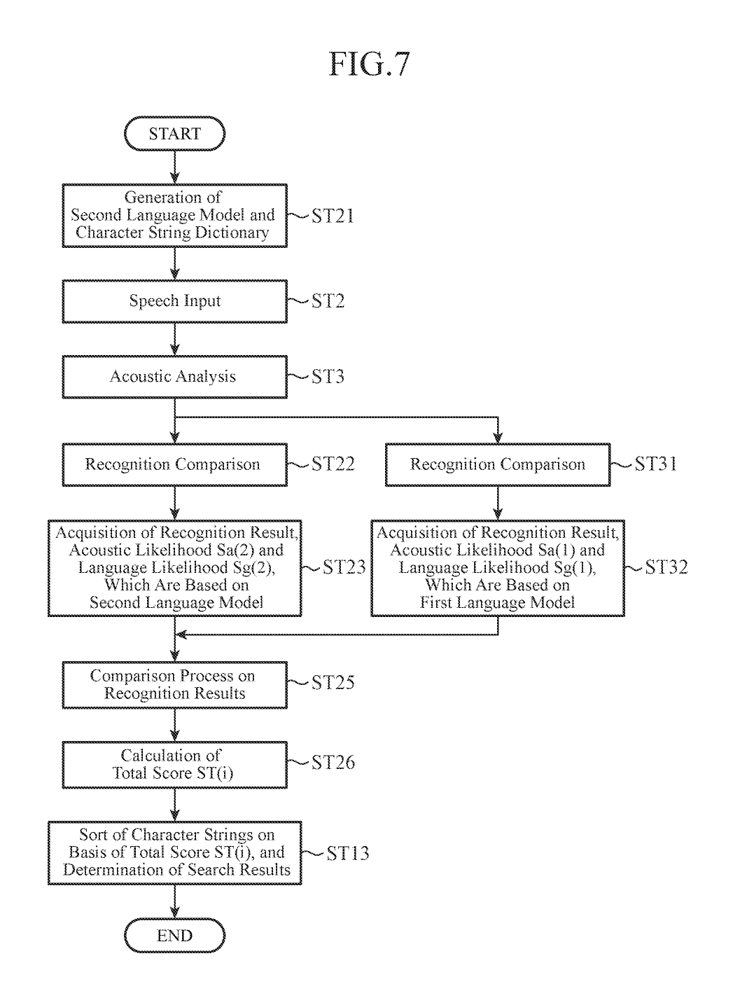

Next, the operation of the speech search device 100b according to Embodiment 3 will be explains while referring to FIG. 7. FIG. 7 is a flow chart showing the operations of the speech search device and the external recognizing device according to Embodiment 3 of the present invention. Hereafter, the same steps as those of the speech search device according to Embodiment 2 are denoted by the same reference characters as those used in FIG. 5, and the explanation of the steps will be omitted or simplified.

The sound search device 100b generates a second language model and a character string dictionary, and stores them in the second language model storage 4 and the character string dictionary storage 7 (step ST21). A first language model which is referred to by the external recognizing device 200 is generated in advance. Next, when speech input is made to the sound search device 100b (step ST2), the acoustic analyzer 1 performs an acoustic analysis on the input speech and converts this input speed into a time series of feature vectors (step ST3). The time series of feature vectors after being converted is outputted to the recognizer 2a and the external recognizing device 200.

The recognizer 2a performs a recognition comparison on the time series of feature vectors after being converted in step ST3 by using the second language model and the acoustic model, to calculate recognition scores (step ST22). The recognizer 2a refers to the recognition scores calculated in step ST22 and acquires a character string which is a recognition result having the highest recognition score with respect to the second language model, and acquires the acoustic likelihood Sa(2) and the language likelihood Sg(2) for the character string according to the second language model, which are calculated in the recognition comparison process of step ST22 (step ST23). The character string acquired in step ST23 is outputted to the character string comparator 6a, and the acoustic likelihood Sa(2) and the language likelihood Sg(2) are outputted to the search result determinator 8b.

In parallel with the processes of steps ST22 and ST23, the external recognition device 200 performs a recognition comparison on the time series of feature vectors after being converted in step ST3 by using the first language model and the acoustic model, to calculate recognition scores (step ST31). The external recognition device 200 refers to the recognition scores calculated in step ST31 and acquires a character string which is a recognition result having the highest recognition score with respect to the first language model, and also acquires the acoustic likelihood Sa(1) and the language likelihood Sg(1) for the character string according to the first language model, which are calculated in the recognition comparison process of step ST31 (step ST32). The character string acquired in step ST32 is outputted to the character string comparator 6a, and the acoustic likelihood Sa(1) and the language likelihood Sg(1) are outputted to the search result determinator 8b.

The character string comparator 6a performs a comparison process on the character string acquired in step ST23 and the character string acquired in step ST32, and outputs character strings each having the highest character string matching score to the search result determinator 8b together with their character string matching scores (step ST25). The search result determinator 8b calculates total scores ST(i) (ST(1) and ST(2)) by using the acoustic likelihood Sa(2) and the language likelihood Sg(2) for the second language model, which are acquired in step ST23, and the acoustic likelihood Sa(1) and the language likelihood Sg(1) for the first language model, which are acquired in step ST32 (step ST26). In addition, by using the character strings outputted in step ST25 and the total scores ST(i) calculated in step ST26, the search result determinator 8b sorts the character strings in descending order of the total scores ST(i) and determines and outputs search results (step ST13), and ends the processing.

As mentioned above, because the speech search device according to this Embodiment 3 is configured in such a way as to perform a recognition process for a certain language model in the external recognizing device 200, the speech search device 100 becomes able to perform the recognition process at a higher speed by disposing the external recognition device in a server or the like having high computational capability.

Although in above-mentioned Embodiment 3 the example of using two language models and performing the recognition process on a character string according to one language model in the external recognizing device 200 is shown, three or more language models can be alternatively used and the speech search device can be configured in such a way as to perform the recognition process on a character string according to at least one language model in the external recognition device.

### Embodiment 4

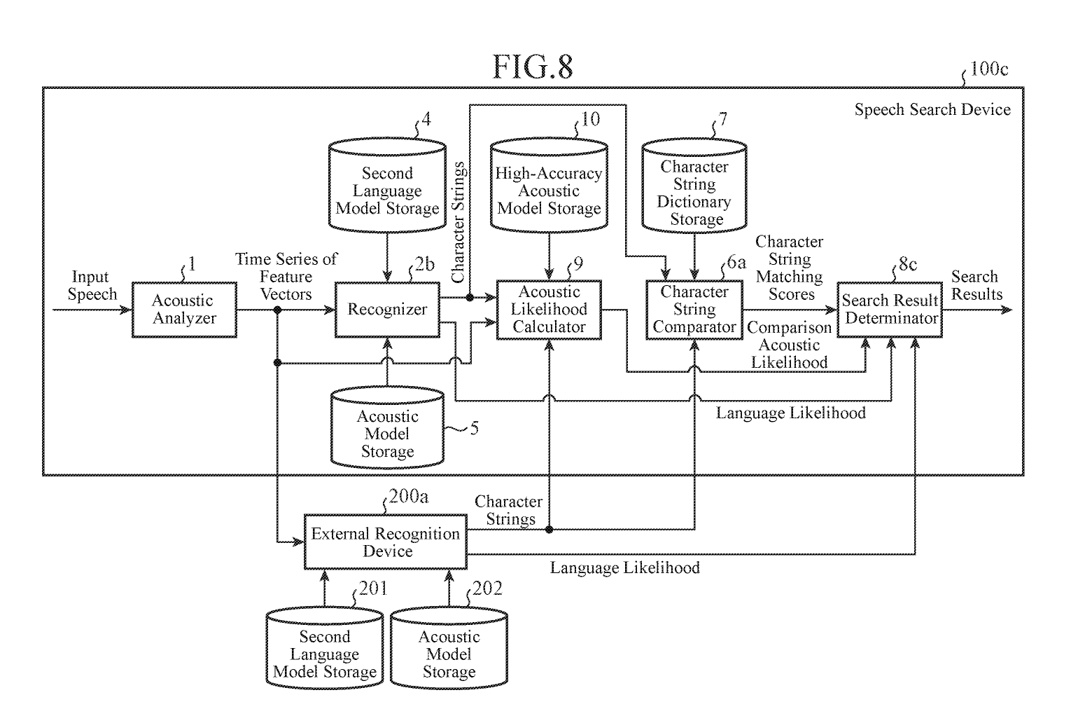

FIG. 8 is a block diagram showing the configuration of a speech search device according to Embodiment 4 of the present invention.

The speech search device 100c according to Embodiment 4 additionally includes an acoustic likelihood calculator 9 and a high-accuracy acoustic model storage 10 that stores a new acoustic model different from the above-mentioned acoustic model, in comparison with the speech search device 100b shown in Embodiment 3.

Hereafter, the same components as those of the speech search device 100b according to Embodiment 3 or like components are denoted by the same reference numerals as those used in FIG. 6, and the explanation of the components will be omitted or simplified.

A recognizer 2b performs a recognition comparison by using a second language model stored in a second language model storage 4 and an acoustic model stored in an acoustic model storage 5, to acquire a character string which is the closest to a time series of feature vectors inputted from an acoustic analyzer 1. The recognizer outputs the character string which is a recognition result whose acquired recognition score is the highest to a character string comparator 6a of the speech search device 100c, and outputs a language likelihood to a search result determinator 8c of the speech search device 100c.

An external recognition device 200a performs a recognition comparison by using a first language model stored in a first language model storage 201 and an acoustic model stored in an acoustic model storage 202, to acquire a character string which is the closest to the time series of feature vectors inputted from the acoustic analyzer 1. The external recognition device outputs the character string which is a recognition result whose acquired recognition score is the highest to the character string comparator 6a of the speech search device 100c, and outputs a language likelihood of that character string to the search result determinator 8c of the speech search device 100c.

The acoustic likelihood calculator 9 performs an acoustic pattern comparison according to, for example, a Viterbi algorithm on the basis of the time series of feature vectors inputted from the acoustic analyzer 1, the character string of the recognition result inputted from the recognizer 2b and the character string of the recognition result inputted from the external recognition device 200a, by using the high-accuracy acoustic model stored in the high-accuracy acoustic model storage 10, to calculate comparison acoustic likelihoods for both the character string of the recognition result outputted from the recognizer 2b and the character string of the recognition result outputted from the external recognition device 200a. The calculated comparison acoustic likelihoods are outputted to the search result determinator 8c.

The high-accuracy acoustic model storage 10 stores the acoustic model whose recognition accuracy is higher than that of the acoustic model stored in the acoustic model storage 5 shown in Embodiments 1 to 3. For example, it is assumed that when an acoustic model in which monophone or diphone phonemes are modeled is stored as the acoustic model stored in the acoustic model storage 5, the high-accuracy acoustic model storage 10 stores the acoustic model in which triphone phonemes each of which takes into consideration a difference between preceding and subsequent phonemes are modeled. In the case of triphones, because the preceding and subsequent phonemes differ between the second phoneme “/s/” of “ [symbol] (/asa/)” and the second phoneme “/s/” of “ [symbol] (/isi/)”, they are modeled by using different acoustic models, and it is therefore known that this results in an improvement in the recognition accuracy.

However, because the types of acoustic models increase, the amount of computation at the time when the acoustic likelihood calculator 9 refers to the high-accuracy acoustic model storage 10 and compares acoustic patterns increases. However, because the target for comparison in the acoustic likelihood calculator 9 is limited to words included in the character string of the recognition result inputted from the recognizer 2b and words included in the character string of the recognition result outputted from the external recognition device 200a, the increase in the amount of information to be processed can be suppressed.

The search result determinator 8c calculates a weighted sum of at least two of the following values including, in addition to the character string matching score outputted from the character string comparator 6a, the language likelihood Sg(i) for each of the two character strings outputted from the recognizer 2b and the external recognition device 200a, and the comparison acoustic likelihood Sa(i) for each of the two character strings outputted from the acoustic likelihood calculator 9, to calculate a total score ST(i). The search result determinator sorts the character strings which are the recognition results in descending order of their calculated total scores ST(i), and sequentially outputs, as a search result, one or more character strings in descending order of the total scores.

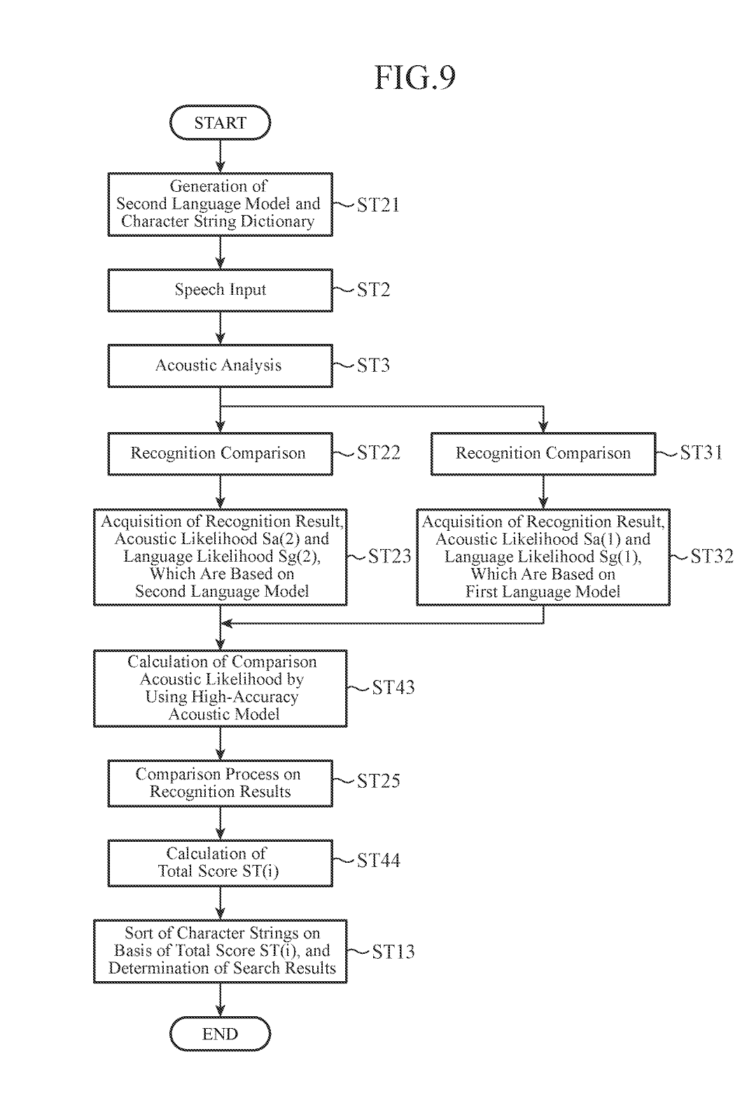

Next, the operation of the speech search device 100c according to Embodiment 4 will be explained while referring to FIG. 9. FIG. 9 is a flow chart showing the operation of the speech search device and the external recognizing device according to Embodiment 4 of the present invention. Hereafter, the same steps as those of the speech search device according to Embodiment 3 are denoted by the same reference characters as those used in FIG. 7, and the explanation of the steps will be omitted or simplified.

After processes of steps ST21, ST2 and ST3 are performed, like in the case of Embodiment 3, the time series of feature vectors after being converted in step ST3 is outputted to the acoustic likelihood calculator 9, as well as to the recognizer 2b and the external recognition device 200a.

The recognizer 2b performs processes of steps ST22 and ST23, outputs a character string acquired in step ST23 to the character string comparator 6a, and outputs a language likelihood Sg(2) to the search result determinator 8c. On the other hand, the external recognition device 200a performs processes of steps ST31 and ST32, outputs a character string acquired in step ST32 to the character string comparator 6a, and outputs a language likelihood Sg(1) to the search result determinator 8c.

The acoustic likelihood calculator 9 performs an acoustic pattern comparison on the basis of the time series of feature vectors after being converted in step ST3, the character string acquired in step ST23 and the character string acquired in step ST32 by using the high-accuracy acoustic model stored in the high-accuracy acoustic model storage 10, to calculate a comparison acoustic likelihood Sa(i) (step ST43). Next, the character string comparator 6a performs a comparison process on the character string acquired in step ST23 and the character string acquired in step ST32, and outputs character strings each having the highest character string matching score to the search result determinator 8c together with their character string matching scores (step ST25).

The search result determinator 8c calculates total scores ST(i) by using the language likelihood Sg(2) for the second language model calculated in step ST23, the language likelihood Sg(1) for the first language model calculated in step ST32, and the comparison acoustic likelihood Sa(i) calculated in step ST43 (step ST44). In addition, by using the character strings outputted in step ST25 and the total scores ST(i) calculated in step ST41, the search result determinator 8c sorts the character strings in descending order of their total scores ST(i) and outputs them as search results (step ST13), and ends the processing.

As mentioned above, because the speech search device according to this Embodiment 4 is configured in such a way as to include the acoustic likelihood calculator 9 that calculates a comparison acoustic likelihood Sa(i) by using an acoustic model whose recognition accuracy is higher than that of the acoustic model which is referred to by the recognizer 2b, a comparison of the acoustic likelihood in the search result determinator 8b can be made more correctly and the search accuracy can be improved.

Although in above-mentioned Embodiment 4 the case in which the acoustic model which is referred to by the recognizer 2b and which is stored in the acoustic model storage 5 is the same as the acoustic model which is referred to by the external recognition device 200a and which is stored in the acoustic model storage 202 is shown, the recognizer and the external recognition device can alternatively refer to different acoustic models, respectively. This is because even if the acoustic model which is referred to by the recognizer 2b differs from that which is referred to by the external recognition device 200a, the acoustic likelihood calculator 9 calculates the comparison acoustic likelihood again and therefore a comparison between the acoustic likelihood for the character string of the recognition result provided by the recognizer 2b and the acoustic likelihood for the character string of the recognition result provided by the external recognition device 200a can be performed strictly.

Further, although in above-mentioned Embodiment 4 the configuration of using the external recognition device 200a is shown, the recognizer 2b in the speech search device 100c can alternatively refer to the first language model storage and perform a recognition process. As an alternative, a new recognizer can be disposed in the speech search device 100c, and the recognizer can be configured in such a way as to refer to the first language model storage and perform a recognition process.

Although in above-mentioned Embodiment 4 the configuration of using the external recognition device 200a is shown, this embodiment can also be applied to a configuration of performing all recognition processes within the speech search device without using the external recognition device.

Although in above-mentioned Embodiments 2 to 4 the example of using two language models is shown, three or more language models can be alternatively used.

Further, in above-mentioned Embodiments 1 to 4, there can be provided a configuration in which a plurality of language models are classified into two or more groups, and the recognition processes by the recognizers 2, 2a and 2b are assigned to the two or more groups, respectively. This means that the recognition processes are assigned to a plurality of speech recognition engines (recognizers), respectively, and the recognition processes are performed in parallel. As a result, the recognition processes can be performed at a high speed. Further, an external recognition device having strong CPU power, as shown in FIG. 8 of Embodiment 4, can be used.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

As mentioned above, the speech search device and the speech search method according to the present invention can be applied to various pieces of equipment provided with a voice recognition function, and, also when input of a character string having a low frequency of appearance is performed, can provide an optimal speech recognition result with a high degree of accuracy.

### EXPLANATIONS OF REFERENCE NUMERALS

1 acoustic analyzer, 2, 2a, 2b recognizer, 3 first language model storage, 4 second language model storage, 5 acoustic model storage, 6, 6a character string comparator, 7 character string dictionary storage, 8, 8a, 8b, 8c search result determinator, 9 acoustic likelihood calculator, 10 high-accuracy acoustic model storage, 100, 100a, 100b, 100c speech search device, 200 external recognition device, 201 first language model storage, and 202 acoustic model storage.

1. A speech search device comprising:
a recognizer to refer to an acoustic model and a plurality of language models having different learning data and perform voice recognition on an input speech, to acquire an acoustic likelihood and a language likelihood of a recognized character string for each of said plurality of language models;
a character string dictionary storage to store a character string dictionary in which pieces of information showing character strings of search target words each serving as a target for speech search are stored;
a character string comparator to compare the recognized character string for each of said plurality of language models, the recognized character string being acquired by said recognizer, with the character strings of the search target words which are stored in said character string dictionary and calculate a character string matching score showing a degree of matching of said recognized character string with respect to each of the character strings of said search target words, to acquire both a character string of a search target word having a highest character string matching score and this character string matching score for each of said recognized character strings; and
a search result determinator to calculate a total score as a weighted sum of two or more of said character string matching score acquired by said character string comparator, and the acoustic likelihood and the language likelihood acquired by said recognizer, and output, as a search result, one or more search target words in descending order of calculated total scores.

2. (canceled)

3. The speech search device according to claim 1, wherein said speech search device comprises an acoustic likelihood calculator to refer to a high-accuracy acoustic model having a higher degree of recognition accuracy than said acoustic model which is referred to by said recognizer, and perform an acoustic pattern comparison between the recognized character string for each of said plurality of language models, the recognized character string being acquired by said recognizer, and said input speech, to calculate a comparison acoustic likelihood, and wherein said recognizer acquires a language likelihood of said recognized character string, and said search result determinator calculates a total score as a weighted sum of two or more of the character string matching score acquired by said character string comparator, the comparison acoustic likelihood calculated by said acoustic likelihood calculator, and the language likelihood acquired by said recognizer, and outputs, as a search result, one or more search target words in descending order of calculated total scores.

4. The speech search device according to claim 1, wherein said speech search device classifies said plurality of language models into two or more groups, and assigns a recognition process performed by said recognizer to each of said two or more groups.

5. A speech search device comprising:
a recognizer to refer to an acoustic model and at least one language model and perform voice recognition on an input speech, to acquire an acoustic likelihood and a language likelihood of a recognized character string for each of said one or more language models;
a character string dictionary storage to store a character string dictionary in which pieces of information showing character strings of search target words each serving as a target for speech search are stored;
a character string comparator to acquire an external recognized character string which is acquired by, in an external device, referring to an acoustic model and a language model having learning data different from that of the one or more language models which are referred to by said recognizer, and performing voice recognition on said input speech, compare the external recognized character string acquired thereby and the recognized character string acquired by said recognizer with the character strings of the search target words stored in said character string dictionary, and calculate character string matching scores showing degrees of matching of said external recognized character string and said recognized character string with respect to each of the character strings of said search target words, to acquire both a character string of a search target word having a highest character string matching score and this character string matching score for each of said external recognized character string and said recognized character string; and
a search result determinator to calculate a total score as a weighted sum of two or more of said character string matching score acquired by said character string comparator, and the acoustic likelihood and the language likelihood of said recognized character string which are acquired by said recognizer, and an acoustic likelihood and a language likelihood of said external recognized character string which are acquired from said external device, and output, as a search result, one or more search target words in descending order of calculated total scores.

6. (canceled)

7. The speech search device according to claim 5, wherein said speech search device comprises an acoustic likelihood calculator to refer to a high-accuracy acoustic model having a higher degree of recognition accuracy than said acoustic model which is referred to by said recognizer, and perform an acoustic pattern comparison between the recognized character string acquired by said recognizer and the external recognized character string acquired by the external device, and said input speech, to calculate a comparison acoustic likelihood, and wherein said recognizer acquires a language likelihood of said recognized character string, and said search result determinator calculates a total score as a weighted sum of two or more of the character string matching score acquired by said character string comparator, the comparison acoustic likelihood calculated by said acoustic likelihood calculator, the language likelihood of said recognized character string which is acquired by said recognizer, and a language likelihood of said external recognized character string which is acquired from said external device, and outputs, as a search result, one or more search target words in descending order of calculated total scores.

8. A speech search method comprising the steps of:
in a recognizer, referring to an acoustic model and a plurality of language models having different learning data and performing voice recognition on an input speech, to acquire an acoustic likelihood and a language likelihood of a recognized character string for each of said plurality of language models;
in a character string comparator, comparing the recognized character string for each of said plurality of language models with character strings of search target words each serving as a target for speech search, the character strings being stored in a character string dictionary, and calculating a character string matching score showing a degree of matching of said recognized character string with respect to each of the character strings of said search target words, to acquire both a character string of a search target word having a highest character string matching score and this character string matching score for each of said recognized character strings; and
in a search result determinator, calculating a total score as a weighted sum of two or more of said character string matching score, and said acoustic likelihood and said language likelihood, and outputting, as a search result, one or more search target words in descending order of calculated total scores.
